(19) United States
(12) Patent Application Publication
(10) Pub. No.: US 2002/0109375 A1
(43) Pub. Date: Aug. 15, 2002

(54) Energy saving method for transportation means

(76) Inventor: Ming-Tung Hung, Taipei (TW)

Correspondence Address: Keith Kline, PRO-TECHTOR INTERNATIONAL SERVICES, 20775 Norada Court, Saratoga, CA, 95070-3018, US

(21) Appl. No.: 09/782,929

(22) Filed: Feb. 13, 2001

(51) Int. Cl. B62D 35/00

(52) U.S. Cl. 296/180.1; 296/211

(57) ABSTRACT

An energy saving method made in the form of a wing, an arc panel or a sail mounted over the roof of transportation means to protect the skin of the transportation means to, lower the power consumption of the air conditioner as a sunshade and to reduce the normal pressure and resistance of friction of the transportation means by creating an uprising force.

### BACKGROUND OF THE INVENTION

a. Field of the Invention

The present invention relates to an energy saving method for transportation means, and more particularly to one mounted over the top of a vehicle in the form of a wing, an arc panel or a sail to create uprising force for reducing energy consumption of the transportation means.

b. Description of the Prior Art

Transportation means including automobiles is a popular, energy-consuming equipment. It is also one of the major sources of air pollution. Prior art of energy saving methods essentially concentrate on improvement of body streamline, engine and combustion efficiency of fuel. According to physic principles, the present invention discloses a means for achieving the same purpose by reducing the normal pressure resulted from the body of the transportation means and its cargo, thus to reduce rolling and sliding frictional resistance particularly when the transportation means is traveling at high speed. In addition, the present invention is also used as a sunshade, gives added value of reducing the power consumption by air conditioners installed in the transportation means.

### SUMMARY OF THE INVENTION

The primary purpose of the present invention is to provide a method that, by applying principles of physics, significantly reduce the resistance due to rolling and sliding friction of a vehicle particularly moving at high speed, thus reduce energy consumption for the vehicle.

The secondary purpose of the present invention is to provide a structure that is made in the shape of a wing, an arc, or a sail mounted at the top of a vehicle to function as a sunshade for reducing the temperature in the vehicle, thus to reduce the energy consumption by the air conditioning system provided in the vehicle.

### BRIEF DESCRIPTION OF THE DRAWINGS

FIG. 1 is a top view of a first preferred embodiment of the present invention in a single deck; and

FIG. 2 is a side view of a second preferred embodiment of the present invention in double decks.

FIG. 3 is a schematic view showing a third preferred embodiment of the present invention in the form of a sail.

FIG. 4 is a schematic view showing a fourth preferred embodiment of the present invention in the form of a single deck of an arc panel.

FIG. 5 is a schematic view showing a fifth preferred embodiment of the present invention in the form of multiple decks of arc panels.

### DETAILED DESCRIPTION OF THE PREFERRED EMBODIMENTS

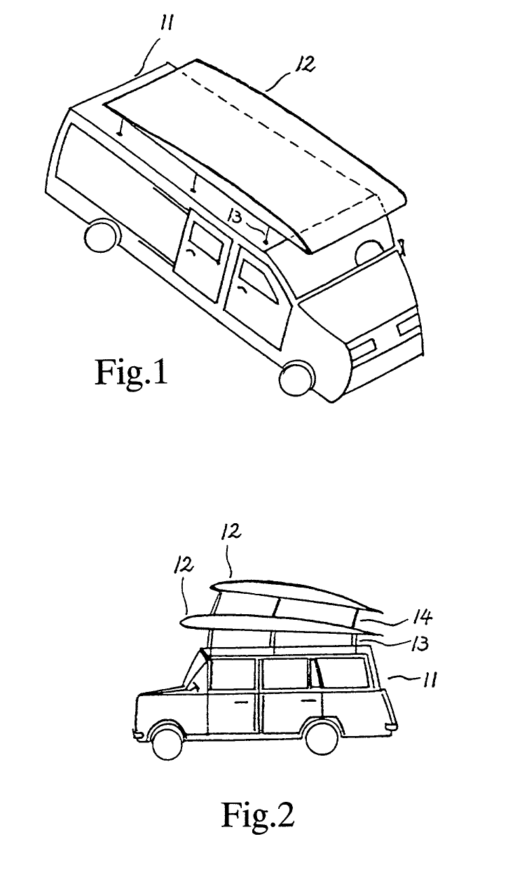

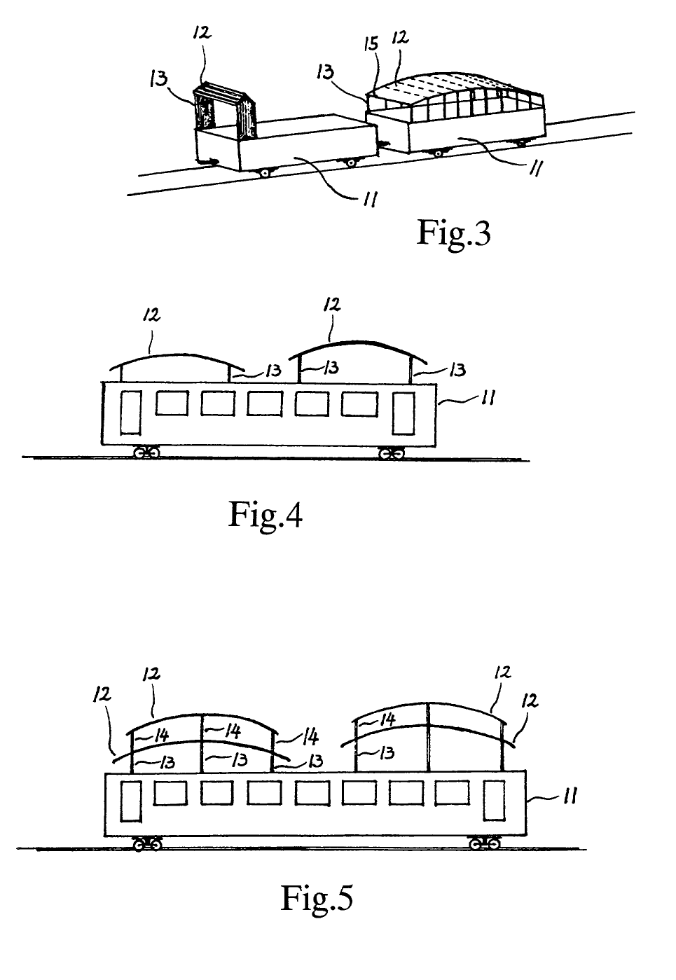

Referring to FIGS. 1 and 2, a structure 12 of the present invention having its length and width both greater than one meter is mounted over the top of a land transportation vehicle, namely, an automobile, a truck or a container truck, and jointly to be hereinafter referred to as a body 11. Said structure 12 creates uprising force when subject to airflow, and is made in the shape of a wing, an arc or a sail with its convex side facing upwards and an attack angle within the range of zero up to fourteen degrees. The structure 12 is connected to the body 11 with multiple links 13 to maintain a proper spacing from the body 11. The structure can be made in a single piece and a single deck of the fixed wing as illustrated in FIG. 1, and in the mobile canvas that can be retracted to facilitate cargo (un) loading operation as illustrated in FIG. 3. In the third preferred embodiment of the present invention as illustrated in FIG. 3, a sliding channel is provided to accommodate the lower end of the multiple links 15. A lateral framework 13 connects the upper end of each pair of symmetrical links of the same height to support the canvas already connected to the lateral framework 15. To prevent interference between two abutted pairs of said links 13, all abutted pairs of said links 13 are not made in the same height. The structure 12 can also be made in multiple decks to be connected above the body 11 as illustrated in FIG. 2. A proper spacing is kept for any abutted decks and all decks are connected with extra links 14. Given with the body with longer cabin and/or cargo loading deck, the structure 12 can be incorporated above the body 11 in a single deck and multiple pieces as illustrated in FIG. 4, or in multiple decks and multiple pieces as illustrated in FIG. 5.

When moving at high speed along with the body 11, the structure 12 creates uprising force to reduce the normal pressure from both of the body 11 and any load on the body, thus to reduce resistance created by rolling and sliding friction. Furthermore, the structure 12 also serves as a sunshade to help reduce the temperature in the body and thus the energy consumed by an air conditioning system installed in the body 11.

The structure 12 provides many advantages. Firstly, the structure 12 serves as the sunshade to reduce power consumption by the air conditioner, and improve driving comforts. When the body 11 is moving at high speed, the uprising force created by the structure 12 reduces the normal pressure from both of the body 11 and its cargo and thus reduce the resistance of rolling and sliding friction. This art of reducing normal pressure and friction resistance is totally different from the prior art and field that seek to achieve the similar purpose by streamline design and engine improvement. Secondly, the structure 12 is not only applicable to vehicle on road or on track with a top, but also to any truck or trailer with opening top or not requiring any sunshade. For example, when the motor vehicle is driving at night, in cloudy days, and cold weather or is loaded with any solid, or liquid or any other cargo that does not require to be maintained at a certain temperature. Energy-saving purpose is achieved simply by reducing the normal pressure and the reduced friction resistance the body 11 is subject to. The energy saving results are even better for long-distance driving at high speed on road or on track. Thirdly, in area where subject to hail, the skin of a car, particularly to the part of the hood, roof and trunk will suffer damage from the hail resulting in numerous of dents and/or holes, particularly for a wagon or other vehicles with thinner skin. With the present invention mounted over the top of the body 11, the car owner has only to repair or replace the structure 12 at a body workshop at much cheaper cost and less time consumption.

It should be noted that the lower ends of the links are not restricted to be provided on the roof or any other specific location of the transportation means, and thus shall not cause any limit to the scope of the claims filed by the present invention. When use this method on a solar energy car, one can add solar energy collecting panel to structure 12, thus enlarge the surface area of the energy panel and increase the capacity of energy saving. This method can extend the cruise mileage of the solar energy car. It can eliminate the limitation of short travelling distance. Structure 12 is in the shape of a wing, the wing can be flat or a strip-like shape. The inner space can be used to store oil or water, etc.

I claim

1. An energy saving method for a transportation means comprised of a member having its length and width greater than one meter and a convex facing upward, mounted at an angle between zero and fourteen degrees over the roof of the transportation means that will create uprising force when subject to the airflow as the transportation is in operation, Said member also serves as a sunshade to reduce power consumption by air conditioners installed in the transportation means, maintains a certain spacing from the body of the transportation means and is connected to the body with multiple links, The uprising force so created reduces the normal pressure from the body and its cargo, thus lowers the resistance caused by friction.

2. An energy saving method for transportation means as claimed in claim 1, the said member is connected above the body of the transportation in a single piece and a single deck.

3. An energy saving method for a transportation means as claimed in claim 1, more than one deck of the member are provided to create more uprising force for the transportation means.

4. An energy saving method for transportation means as claimed in claim 1, the said member is connected above the body of the transportation in a single deck and multiple pieces.

5. An energy saving method for transportation means as claimed in claim 1, the said member is connected above the body of the transportation in multiple pieces and multiple decks.

6. An energy saving method for a transportation means as claimed in claims 1, the said member is provided in a form of a wing.

7. An energy saving method for a transportation means as claimed in claims 2, the said member is provided in a form of a wing.

8. An energy saving method for a transportation means as claimed in claims 3, the said member is provided in a form of a wing.

9. An energy saving method for a transportation means as claimed in claims 4, the said member is provided in a form of a wing.

10. An energy saving method for a transportation means as claimed in claims 5, the said member is provided in a form of a wing.

11. An energy saving method for a transportation means as claimed in claims 1, the said member is provided in a form of an arc panel.

12. An energy saving method for a transportation means as claimed in claims 2, the said member is provided in a form of an arc panel.

13. An energy saving method for a transportation means as claimed in claims 3, the said member is provided in a form of an arc panel.

14. An energy saving method for a transportation means as claimed in claims 4, the said member is provided in a form of an arc panel.

15. An energy saving method for a transportation means as claimed in claims 5, the said member is provided in a form of an arc panel.

16. An energy saving method for a transportation means as claimed in claims 1, the said member is provided in a form of a canvas sail.

17. An energy saving method for a transportation means as claimed in claims 2, the said member is provided in a form of a canvas sail.

18. An energy saving method for a transportation means as claimed in claims 3, the said member is provided in a form of a canvas sail.

19. An energy saving method for a transportation means as claimed in claims 4, the said member is provided in a form of a canvas sail.

20. An energy saving method for a transportation means as claimed in claims 5, the said member is provided in a form of a canvas sail.
